(19) United States
(12) Patent Application Publication
(10) Pub. No.: US 2018/0236935 A1
(43) Pub. Date: Aug. 23, 2018

(54) LAND VEHICLE FOR PUBLIC TRANSPORT, SUCH AS A BUS, WITH IMPROVED BRIGHTNESS

(71) Applicant: BLUEBUS, Ergue Gaberic (FR)

(72) Inventors: Patrice BESSON, Marennes (FR); Thierry SAUVAGET, Toussieu (FR)

(73) Assignee: BLUEBUS

(21) Appl. No.: 15/551,021

(22) PCT Filed: Nov. 9, 2016
(86) PCT No.: PCT/EP2016/077102

§ 371 Date: Aug. 14, 2017

(30) Foreign Application Priority Data
Nov. 16, 2015 (FR) 1560971

(51) Int. Cl. B60Q 3/43

(52) U.S. Cl. CPC B60Q 3/43; B60H 1/245; B60Y 2200/143

(57) ABSTRACT

A public transport land vehicle, in particular of the bus type, includes a passenger compartment intended to accommodate several people, and at least one technical compartment which can be accessed from the passenger compartment, at least one technical compartment, called upper compartment, is arranged on/in the upper wall of the passenger compartment.

The present invention relates to a public transport land vehicle, of the bus or tyred tram type, the light level in the passenger compartment of which is improved.

The field of the invention is the field of land vehicles, in particular electric public transport vehicles of the bus, coach or tyred tram type.

### BACKGROUND OF THE INVENTION

Passenger compartments of public transport vehicles, of the bus or tram type, generally comprise one or more technical compartments which can be accessed from inside said passenger compartment. These technical compartments can have various forms. Nevertheless, in most cases, these technical compartments have the form of longitudinal conduits placed on a side wall of the passenger compartment and more particularly at a join of the side wall with the upper wall, in other words at an upper corner of the passenger compartment.

Now, when a technical compartment is placed at an upper corner of the passenger compartment, this reduces the quantity of light entering the passenger compartment, because the technical compartment constitutes an obstacle to external light entering into the passenger compartment. Consequently, most public transport vehicles suffer from a low level of natural light which must be compensated for by lighting, even in the middle of the day.

This results in increased consumption of electrical energy within the passenger compartment, which has a significant cost. In addition, in the case of electric vehicles, this reduces the operating range of the vehicle.

A purpose of the present invention is to overcome these drawbacks.

Another purpose of the invention is to propose a vehicle the natural light level inside the passenger compartment of which can be improved.

Another purpose of the invention is also to propose a vehicle the electrical consumption of which is reduced and/or the electrical operating range is increased.

### SUMMARY OF THE INVENTION

The invention makes it possible to achieve at least one of these aims by means of a public transport land vehicle, in particular of the bus type, comprising a passenger compartment intended to accommodate several people seated or standing in an aisle and at least one technical compartment which can be accessed from said passenger compartment, characterized in that at least one technical compartment, called upper compartment, is arranged on/in the upper wall of said passenger compartment.

Thus, in the vehicle according to the invention, the one or more technical compartments (or at least a part of the technical compartments) are arranged in/on the upper wall and not at the top part of a side wall or of a join of the side wall with the upper wall, as is the case in public transport vehicles known today.

As a result, in the vehicle according to the invention, it is possible to not occupy the upper part of at least one, in particular of each, side wall with a technical compartment, this part then being able to be arranged so as to be at least partly transparent or to contain one or more windows so as to allow natural light to pass into the passenger compartment. The light level in the passenger compartment is then improved. In addition, the vehicle according to the invention then uses less artificial light in the passenger compartment, which reduces its electrical consumption and increases the operating range of the vehicle when it is an electric vehicle. In addition, the ergonomics of the vehicle is also improved for users because natural light is more beneficial to them than artificial light.

It should be noted that, according to the invention, by “technical compartment” is meant a compartment for:
ventilation,
lighting,
display, and/or
housing pipes or electrical cables.

In addition, by “tyred tram” is meant an electric public transport land vehicle mounted on wheels and which is recharged at each station, so that there is no need for heavy infrastructure of the rails or catenaries type on the road system. Such an electric vehicle is recharged at each station by means of charging elements of the station and a connector connecting said vehicle to said station.

Preferably, at least one, in particular each, upper technical compartment can be arranged in a central area of the upper wall.

Thus, the obstacle that these technical compartments could form to natural light passing into the passenger compartment is reduced, or even eliminated.

In addition, the central area of the upper wall constitutes a suitable area, making it possible to cover, in an effective and centralized manner, the whole of the passenger compartment, when the technical compartment is a ventilation, lighting or display conduit.

Furthermore, the central area is in a part of the passenger compartment where the height between the floor and the ceiling of the passenger compartment can be adapted more easily in comparison with other areas of the passenger compartment.

In a particularly preferred version of the vehicle according to the invention, at least one, in particular each, upper technical compartment can have the form of a longitudinal conduit extending in the longitudinal direction of said passenger compartment, over at least a part of the length of the vehicle.

Such a technical compartment makes it possible to cover the whole of the passenger compartment effectively, and can, for example, serve to connect the front part of the passenger compartment to the rear part of the passenger compartment.

The vehicle according to the invention can, in an embodiment that is in no way limitative, comprise several upper technical compartments, each having the form of a longitudinal conduit, extending in the longitudinal direction of said passenger compartment, for example substantially parallel to one another, in particular over at least a part of the length of said passenger compartment.

For example, the vehicle according to the invention can comprise a first upper longitudinal conduit for ventilating the passenger compartment, a second upper longitudinal conduit for the lighting, a third upper longitudinal conduit for display, a fourth upper longitudinal conduit for housing electrical cables etc. At least two of these conduits can be parallel to one another and have the same length or different lengths.

Advantageously, at least one upper technical compartment can comprise longitudinal side vents making it possible for air to pass from the outside to the inside of said vehicle.

According to an embodiment example which is in no way limitative, the vehicle according to the invention can comprise:
two upper technical compartments for ventilation, and
an upper technical compartment for lighting, positioned between said upper technical compartments for ventilation;
   said compartments each having the form of a longitudinal conduit, extending in the longitudinal direction of said passenger compartment, in particular substantially parallel to one another.

Moreover, when the vehicle comprises several upper technical compartments, at least two upper technical compartments can be adjacent.

In this case, at least two adjacent upper technical compartments can contain a common wall, so as to reduce the weight of said compartments and to reduce the cost of producing said compartments.

Advantageously, the vehicle according to the invention can comprise at least one, in particular two longitudinal side walls, the upper part of which, in particular at the join with the upper wall, is at least partially transparent, or comprises at least one window or skylight, allowing light to pass to the inside of the passenger compartment.

Thus, the level of light entering the passenger compartment is increased.

In addition, at least one upper technical compartment can be provided with a cover which rotates between a closed position, preventing access to said upper technical compartment, and an open position, allowing access to said upper technical compartment.

At least one upper technical compartment can be provided with at least one means of holding the cover of said compartment in an open position.

Such a support means can comprise a support part against which the cover is supported when it is in an open position.

Such a support means can alternatively comprise a means of retaining the cover of the spring or cylinder type operated either independently of the rotation of the cover or during rotation of the cover.

Such a means of holding in an open position can also comprise a counterweight adequately arranged on the cover.

Such a support means makes intervention by an operator even more ergonomic. In fact, the cover being supported in the open position by the support means, the operator does not have to worry about it during his intervention.

According to the invention, at least one technical compartment can be provided with at least one means for locking the cover of said compartment in a closed position.

Such a locking means can for example be a lock which cannot be locked or unlocked without a key.

Such a locking means makes it possible to prevent access to the technical compartment by unauthorized persons.

Moreover, at least one upper technical compartment can be provided with several covers.

In this case, at least one of said covers can be opened independently of the other covers, so as to allow access to a part of said upper technical compartment.

Moreover, at least one upper technical compartment can comprise at least one opening for a cable or fluid to pass through, or even an opening for communicating with another compartment, technical or otherwise, in the passenger compartment or outside the passenger compartment.

According to the invention, at least one technical compartment of the vehicle can be made from plastic or from metal. Similarly, at least one rotating cover of at least one technical compartment can be made from plastic or from metal.

In a preferred version, the vehicle according to the invention can be a bus, a coach or a tyred tram, in particular electric.

### DESCRIPTION OF THE FIGURES AND EMBODIMENTS

Other advantages and characteristics will become apparent on examination of the detailed description of an embodiment which is in no way limitative, and the attached drawings, in which:

FIG. 1 is a partial diagrammatic representation of a vehicle according to the prior art;

FIGS. 2-4 are partial diagrammatic representations of a first example of a vehicle according to the invention;

FIGS. 5-8 are diagrammatic representations of other examples of a vehicle according to the invention; and

FIG. 9 is a non-limitative embodiment example of a vehicle according to the invention.

It is understood that the embodiments which will be described below are in no way limitative. In particular, variants of the invention can be envisaged that comprise only a selection of the characteristics described below in isolation from the other characteristics described, if this selection of characteristics is sufficient to provide a technical advantage or to differentiate the invention from the state of the art. This selection comprises at least one, preferably functional, characteristic without structural details, or with only a part of the structural details if this part alone is sufficient to confer a technical advantage or to differentiate the invention with respect to the state of the prior art.

In the figures, components common to several figures retain the same reference.

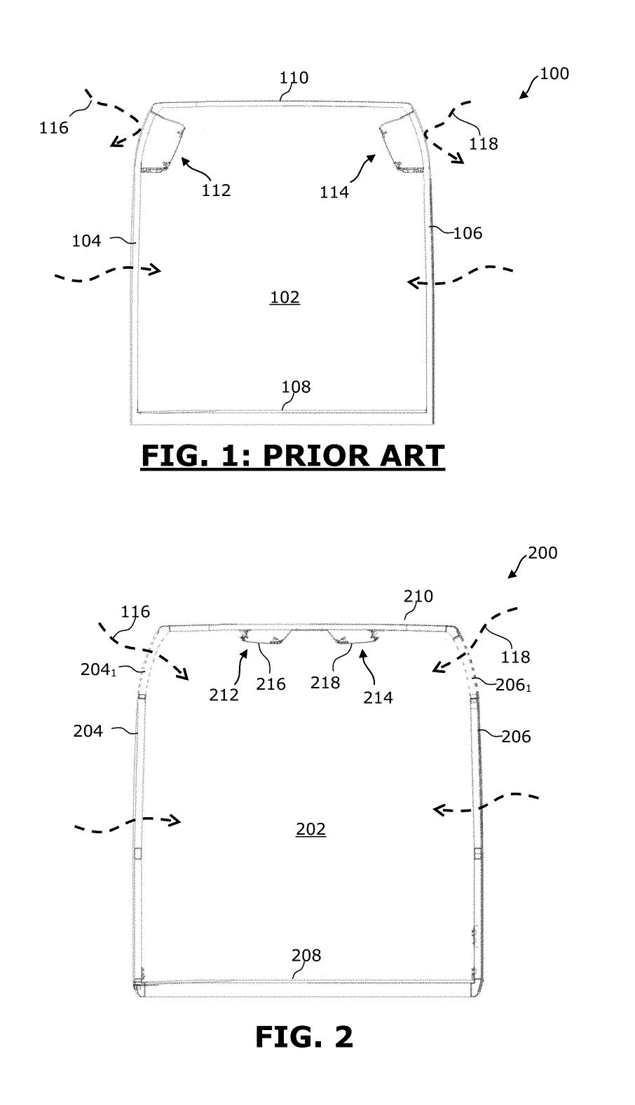

FIG. 1 is a partial diagrammatic representation of an embodiment example of a vehicle according to the prior art.

The vehicle 100 is shown in FIG. 1 in a highly simplified form following a cross-sectional view according to a cross-sectional plane perpendicular to the longitudinal direction of the vehicle, in order to facilitate understanding.

The vehicle 100 comprises a passenger compartment 102 delimited by two longitudinal side walls 104 and 106 that are substantially vertical, a lower wall 108 and an upper wall 110 that are substantially horizontal. In FIG. 1, the rear wall, respectively the front wall, delimiting the passenger compartment at the back, respectively at the front, are not shown.

The vehicle 100 comprises, arranged in the passenger compartment, a technical compartment 112 placed at an upper corner of the passenger compartment 102 at the join between the side wall 104 and the upper wall 110. The vehicle comprises a technical compartment 114 placed at the level of an upper corner of the passenger compartment 102 at the level of the join between the side wall 106 and the upper wall 110. The technical compartments 112 and 114 are opaque and constitute an obstacle to entry into the passenger compartment 102 of the vehicle 100 of external natural light indicated by the dotted arrows 116 and 118.

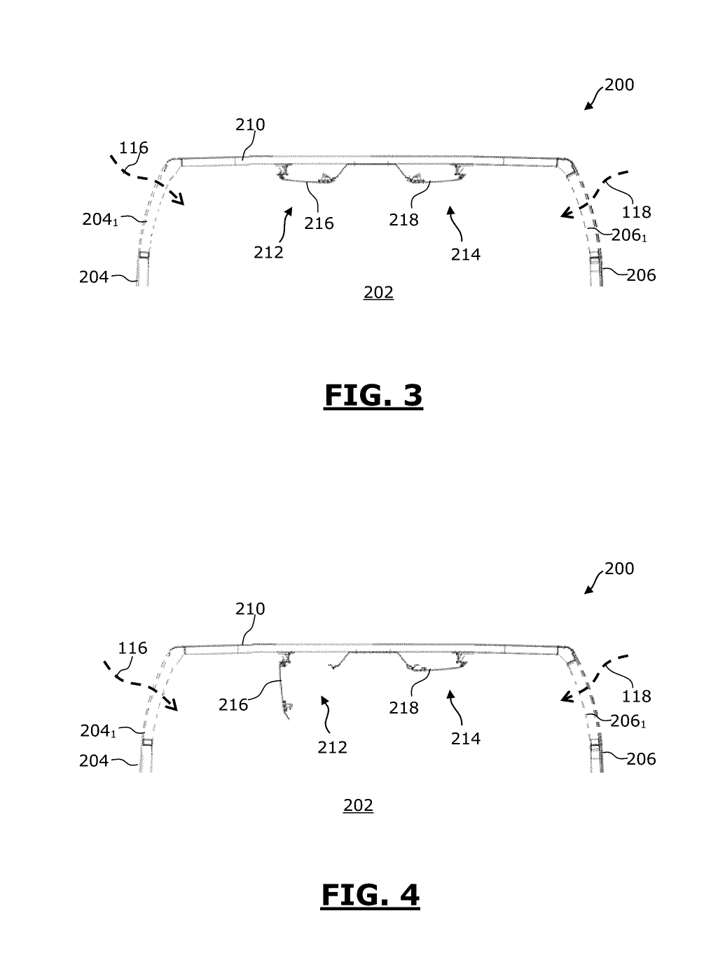

FIGS. 2-4 are partial diagrammatic representations of a first example of a vehicle according to the invention.

The vehicle 200 according to the invention is shown in FIG. 2 in highly simplified form, following a cross-sectional view according to a cross-sectional plane perpendicular to the longitudinal direction of the vehicle, in order to facilitate understanding.

The vehicle 200, like the vehicle 100 in FIG. 100, comprises a passenger compartment 202, longitudinal side walls 204 and 206, a lower wall 208 and an upper wall 210.

The vehicle 200 in FIG. 2 also comprises two technical compartments 212 and 214 similar or identical to the technical compartments 112 and 114 of the vehicle 100 in FIG. 1.

Unlike the vehicle 100 in FIG. 1, in the vehicle 200 in FIG. 2, the technical compartments 212 and 214 are arranged on the upper wall 210 of the passenger compartment 202, in a central area of said upper wall 210.

As a result, the upper corner of the passenger compartment 202 at the join between the side wall 204 and the upper wall 210 is freed and the natural light indicated by the arrow 116 can enter into the passenger compartment 202 through a window or a skylight 2041 (shown by a dotted line in FIG. 2) arranged at the upper part of the side wall 204. Similarly, the upper corner of the passenger compartment 202, at the join between the side wall 206 and the upper wall 210, is freed and the natural light indicated by the arrow 118 can enter into the passenger compartment through a window or a skylight 2061 (shown by a dotted line in FIG. 2) arranged at the upper part of the side wall 206. This solution thus makes it possible to increase the number of openings for lighting allowing external light to enter the vehicle. In particular, the light level in the passenger compartment 202 of the vehicle 200 is improved with respect to the light level of the passenger compartment 102 of the vehicle 100, since it receives an almost vertical light originating from outside, which is therefore more effective for the light level in the passenger compartment, in addition to light rays that are almost horizontal (also shown by dotted arrows in FIG. 2) on the vertical windows of the walls of the vehicle.

Of course, alternatively, only one of the upper corners of the passenger compartment can comprise a skylight and the other upper corner can comprise a conventional technical compartment, not allowing external light to pass through. FIG. 8 gives a diagrammatic representation of a vehicle 800 according to this alternative.

FIGS. 3 and 4 show diagrammatic representations of the upper wall 210 of the vehicle 200 in FIG. 2 equipped with technical compartments.

Each technical compartment 212-214 has the form of a longitudinal conduit arranged on the upper wall 210, in a central area of said upper wall 210. Each longitudinal technical conduit 212-214 extends substantially horizontally over at least one part of, in particular over all of, the length of the upper wall 210.

Each technical conduit 212-214 is provided with a cover, 216 and 218 respectively. Each cover 216-218 is intended to rotate about a longitudinal horizontal axis between a closed position preventing access to the inside of the technical conduit 212-214, and an open position, allowing access to the inside of the technical conduit 212-214.

FIG. 3 is a diagrammatic representation of the technical conduits 212-214 of the vehicle 200 in FIG. 2 with the covers 216-218 of the conduits 212-214 in a closed position.

FIG. 4 is a diagrammatic representation of the technical conduits 212-214 of the vehicle 200 of FIG. 2 with the cover 216 of the conduit 212 in an open position and the cover 218 of the technical conduit 214 in a closed position.

Each technical conduit 212-214 comprises a lock making it possible to lock the cover 216-218 of said conduit 212-214 in a closed position against the rest of the technical conduit 212-214.

Each technical conduit 212-214 also comprises a means (not shown) of holding the cover 216-218 of said conduit 212-214 in an open position. Such means of holding the cover in an open position comprises any combination of the following elements: a cylinder, a spring, a counterweight or a stop part.

It should be remembered that each technical conduit is shown empty in the figures in order to facilitate understanding and to not overload the figures.

In addition, each technical conduit of a vehicle according to the invention can be used as a housing for cables or pipes to transport a fluid such as air conditioning fluid, to house a display means and/or a lighting means etc.

In the example given in FIGS. 2-4, the upper technical conduits 212-214 can be used for ventilation within the passenger compartment 202 of the vehicle 200.

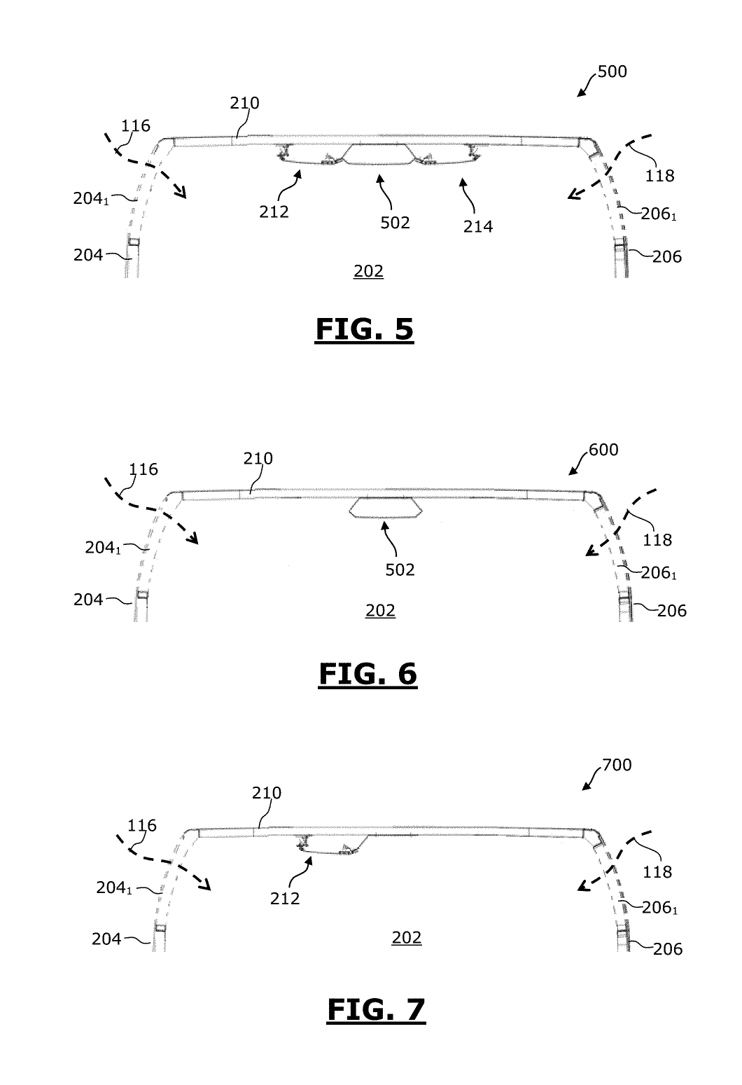

In addition, the number and the arrangement of the upper technical conduits on the upper wall 210 is not limited to that which has just been described with reference to FIGS. 2-4. FIGS. 5-7 give other embodiment examples.

FIG. 5 is a partial diagrammatic representation of another embodiment example of a vehicle according to the invention.

More precisely, FIG. 5 shows a partial representation of the upper wall of a vehicle 500 according to the invention.

The vehicle 500 comprises all of the elements of the vehicle 200 in FIGS. 2-4.

In addition, the vehicle 500 comprises a longitudinal upper technical conduit 502 placed between the technical conduits 212 and 214.

The longitudinal upper technical conduit 502 is arranged between the technical conduits 212 and 214 so that the three conduits 502, 212 and 214 are adjacent. In addition, the adjacent conduits 502 and 212 contain a common side wall. The conduits 502 and 214 also contain a common side wall.

The conduit 502 can be similar or identical to, or also different from the conduits 212 and 214.

In the example shown in FIG. 5, the technical conduit 502 is a conduit serving to light the passenger compartment and the conduits 212-214 are used for ventilation within the passenger compartment of the vehicle 500.

According to an embodiment example, the conduit 502 can be used to house artificial lighting for the passenger compartment 202, for example electric lighting carried out by LEDs. Alternatively or in addition, the conduit 502 can be used to allow natural lighting to enter the passenger compartment 202, in combination with a roof which is at least partially transparent.

FIG. 6 is a partial diagrammatic representation of another embodiment example of a vehicle according to the invention.

More precisely, FIG. 6 shows a partial representation of the upper wall of a vehicle 600 according to the invention.

In the example shown in FIG. 6, the vehicle 600 only contains the upper technical conduit 502 of the vehicle 500 in FIG. 5. The vehicle 600 does not comprise the technical conduits 212 and 214.

FIG. 7 is a partial diagrammatic representation of another embodiment example of a vehicle according to the invention.

More precisely, FIG. 7 shows a partial representation of the upper wall of a vehicle 700 according to the invention.

In the example shown in FIG. 7, the vehicle 700 only contains the upper technical conduit 212 of the vehicle 500 in FIG. 5. The vehicle 700 does not contain the technical conduits 214 and 502.

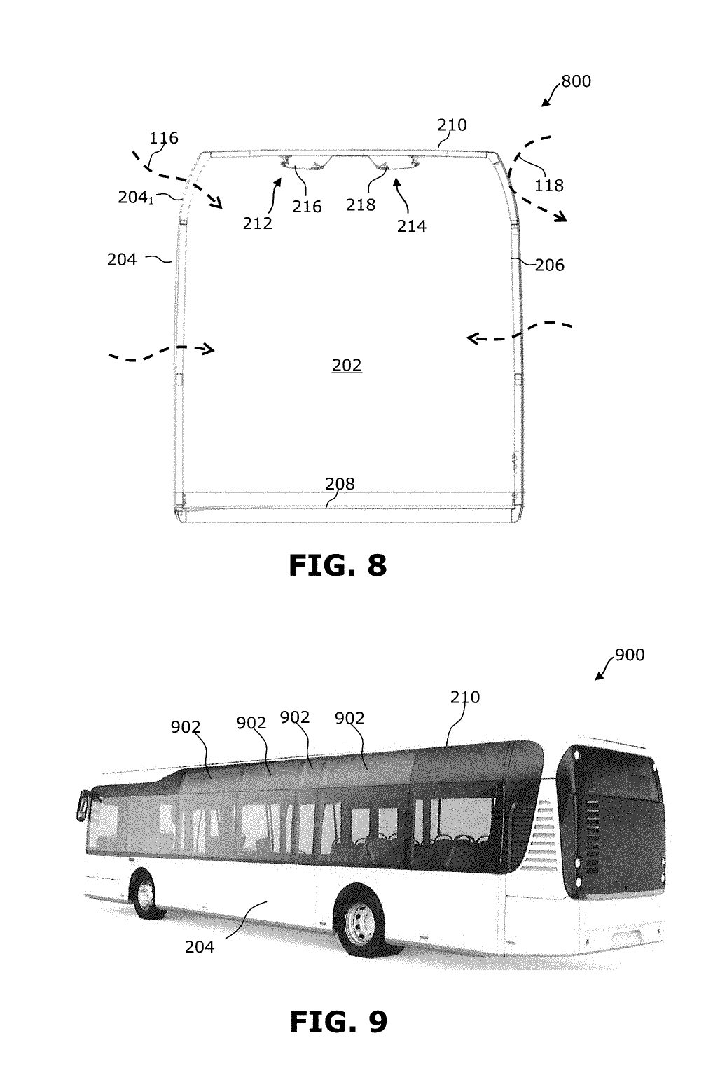

FIG. 9 is a diagrammatic representation of an embodiment example of a vehicle according to the invention, viewed from outside the passenger compartment of said vehicle.

The vehicle 900 shown in FIG. 9 is a bus which comprises transparent windows 902 at the join between the side wall 204 and the upper wall 210, allowing light to pass from the outside to the inside of said bus 900.

The windows 902 are placed on only one part of the bus 900, and more particularly in a central area of the bus 900.

According to the invention, at least one technical compartment of the vehicle according to the invention can be made from plastic or from metal. Similarly, at least one rotating cover of at least one technical compartment can be made from plastic or from metal.

Of course, the invention is not limited to the examples detailed above. The vehicle according to the invention can comprise at least one additional technical compartment different to the one or more upper technical compartments which have just been described.

1. A public transport land vehicle, in particular of the bus type, comprising: a passenger compartment intended to accommodate several people seated or standing in an aisle; several technical compartments, called upper compartments, which can be accessed from said passenger compartment, arranged on/in the upper wall of said passenger compartment and each having the form of a longitudinal conduit;
two upper technical compartments for ventilation; and
an upper technical compartment for lighting, positioned between said upper technical compartments for ventilation.

2. The vehicle according to claim 1, characterized in that at least one upper technical compartment is arranged in a central area of the upper wall.

3. The vehicle according to claim 1, characterized in that at least one upper technical compartment has the form of a longitudinal conduit extending in the longitudinal direction of said passenger compartment, over at least a part of the length of said passenger compartment.

4. The vehicle according to claim 1, characterized in that it also comprises at least one upper technical compartment for:
display, and/or
housing pipes or electrical cables.

5. The vehicle according to claim 1, characterized in that at least one upper technical compartment comprises longitudinal side vents which make it possible for air to pass from the outside to the inside of said vehicle.

6. The vehicle according to claim 1, characterized in that it comprises at least two adjacent upper compartments, containing a common wall.

7. The vehicle according to claim 1, characterized in that it comprises at least one, in particular two, longitudinal side wall(s) the upper part of which, in particular at the join with the upper wall, is at least partially transparent, or comprises at least one window or skylight allowing light to pass to the inside of the passenger compartment.

8. The vehicle according to claim 1, characterized in that at least one upper technical compartment is provided with a cover which rotates between a closed position, preventing access to said upper technical compartment, and an open position, allowing access to said upper technical compartment.

9. The vehicle according to claim 8, characterized in that at least one upper technical compartment is provided with at least one means of holding the cover of said compartment in an open position.

10. The vehicle according to claim 8, characterized in that at least one upper technical compartment is provided with at least one means for locking the cover of said compartment in a closed position.

11. The vehicle according to claim 1, characterized in that at least one upper technical compartment is provided with several covers, at least one of said covers being able to be opened independently of the other covers.

12. The vehicle according to claim 1, characterized in that at least one upper technical compartment comprises at least one opening for a cable or fluid to pass through, or also an opening for communicating with another compartment, technical or otherwise, located in the passenger compartment or outside the passenger compartment.

13. The vehicle according to claim 1, characterized in that at least one upper technical compartment is made from plastic or from metal.

14. The vehicle according to claim 1, characterized in that it is a bus, coach or tired tram, in particular electric.
